(19) United States
(12) Patent Application Publication
(10) Pub. No.: US 2025/0050582 A1
(43) Pub. Date: Feb. 13, 2025

(54) Device for the additive manufacturing of components

(71) Applicant: KURTZ GMBH & CO KG, Kreuzwertheim (DE)

(72) Inventors: Uwe Rothaug, Marktheidenfeld (DE); Victor Romanov, Wertheim (DE)

(21) Appl. No.: 18/720,226

(22) PCT Filed: Dec. 19, 2022
(86) PCT No.: PCT/EP2022/086814

§ 371 Date: Jun. 14, 2024

(30) Foreign Application Priority Data
Dec. 17, 2021 (DE) 10 2021 133 722.4

(51) Int. Cl. B29C 64/268; B22F 10/28; B22F 10/31; B22F 12/47; B22F 12/48; B29C 64/153; B29C 64/236; B29C 64/241; B29C 64/393; B33Y 10/00; B33Y 30/00; B33Y 50/02

(52) U.S. Cl. CPC B29C 64/268; B22F 10/28; B22F 10/31; B22F 12/47; B22F 12/48; B29C 64/153; B29C 64/236; B29C 64/241; B29C 64/393; B33Y 10/00; B33Y 30/00; B33Y 50/02; B22F 2998/10

(57) ABSTRACT

According to the invention, a device for the additive manufacturing of components, preferably by means of selective melting or sintering, in particular by means of a powder bed based laser beam melting process, is provided, which has a control device. Modules of the device for the additive manufacturing of components can be exchanged without any further set-up procedure, so that the device for the additive manufacturing of components can be quickly reconfigured.

The invention relates to a device and a method for the additive or generative manufacturing of components.

DE 10 2016 222 068 A1 describes a device and a method for generative component production with several spatially separated steel guides. A processing head has several optical switching elements via which several beams can be directed to the target position. The processing head can be moved along a linear axis. The linear axis is in turn slidably mounted on a vertical-perpendicular linear axis. This enables an X-Y movement. The laser beam source or sources are mounted on the linear axis.

WO 2018/202643 A1 discloses a device for additive manufacturing by selective laser sintering. One or more lasers are assigned to one or more laser heads. These lasers are distributed to the individual heads via the beam splitters. The heads can be moved along rails in the X and Y directions. The heads can be moved independently of each other. The light supply to the heads is realised by mirrors.

U.S. Pat. No. 10,399,183 B2 describes an additive manufacturing process in which an optical head is supplied with a laser beam via an optical fibre. This allows several laser beams to be directed to the same head and to be emitted from it in parallel. This enables parallel melting points on the surface of the powder bed.

A similar process is described in U.S. Pat. No. 10,399,145 B2.

US 2015/0283612 A1, US 2014/0198365 A1 and JP2009-65 09A disclose selective laser sintering devices that have several optical heads that can direct laser beams onto a powder bed. These heads themselves cannot be moved in the X and Y directions, but instead direct the laser beam into the corresponding positions via mirrors. The advantage of this is that the laser focal point can be moved quickly. However, the heads must be comparatively far away from the powder bed and can only illuminate a limited area.

DE 10 053 742 C5, U.S. Pat. No. 9,011,136 B1 and CN 206065685 U show devices for sintering with a cross-slide arrangement, an additive manufacturing process with several heads for plastic printing and a device with a head that has both a 3D printer and a 3D cutting element.

US 2019/0009333 A1 discloses a device and method for selective laser melting, wherein a plurality of laser heads operating in parallel are provided for melting a material according to a powder bed based laser melting process. Each of the laser heads is movable along a linear rail device and the laser heads can be moved independently of each other. The array of laser heads and the powder bed surface can be rotated horizontally relative to each other.

US 2017/0129012 A1 describes a device and a method for the additive manufacturing of components, wherein the device comprises several robot arms, on each of which a deposition head and a laser head are mounted adjacent to one another. The robot arms each comprise at least one swivel joint and are designed to move the deposition head and the laser head in all three spatial directions. In this way, material can be applied to a processing surface by means of the deposition head and this area can be melted with the laser immediately afterwards.

CN 106 312 574 A discloses a device comprising equipment for additive manufacturing processes and milling processes. The device essentially comprises several robot arms, which can be equipped with gripper elements for providing material on a work platform or for removing finished components or with a laser head. The robot arms each comprise two joints and are therefore mounted so that they can be rotated and swivelled. The device also comprises a central production arm, which can be equipped with a laser head or a milling head. The central production arm can be moved linearly along a rail system.

DE 10 2018 128 543 A1 features a laminating moulding device in which two laser heads operating in parallel are provided for melting a material in accordance with a laminating moulding process. Both laser heads are coupled to a rail device and can be moved linearly independently of each other. The rail device can also be moved. This allows the processing area to be completely covered. The laser beam is guided to the processing area by a focusing unit using two mirror elements.

CN 206 065 685 U describes a device and a method for 3D printing, wherein a laser for melting a starting material and a cutting laser for processing the structures produced are provided. The laser for melting a starting material and the cutting laser can be moved both horizontally and vertically independently of each other along several rail devices.

The object of the present invention is to provide a device and a method for the additive manufacturing of components, preferably by means of selective melting or sintering, which can be flexibly adapted to differently dimensioned components.

A further task of the present invention is to provide a device and a method for the additive manufacturing of components which are simple in design, allow a high manufacturing speed and with which 3d components can be manufactured with high precision.

One or more of these tasks are solved by a device having the features of independent patent claim 1 and by a method having the features of claim 15. Advantageous embodiments are given in the dependent subclaims.

According to the invention, a device for the additive manufacturing of components, preferably by means of selective melting or sintering, is provided. This comprises at least one module with a processing head for directing a light beam onto a processing area, and a swivel arm, on which the processing head is arranged, and a carriage, on which the swivel arm is rotatably mounted, wherein the module can be moved along a rail device, and a control device in which module parameters can be stored which define predetermined properties of the module, wherein the control device is set up and designed to control different modules using the module parameters, so that modules can be exchanged in the device for the additive manufacturing of components and these can preferably be controlled by the control device without any further set-up procedure.

Because the control device is set up and designed to control different modules using the module parameters, modules can be exchanged for other modules as required or modules can be removed or added in order to change a configuration of the additive manufacturing device so that the device can be converted and adapted accordingly, for example for manufacturing large numbers of components or for manufacturing components in the shortest possible time or for manufacturing components with high quality.

Since the module parameters are or can be stored in the control device, the control device can control different modules and correspondingly different configurations of the additive manufacturing device with different modules, which are interchangeable. Despite these changes, the device is able to control the different modules or configurations of the additive manufacturing device.

Thus, the device according to the invention can be adapted as desired or almost as desired to a different number of components to be manufactured and to different requirements in terms of production time and quality, such as porosity or surface quality. In principle, the configuration should be optimised in such a way that a high number of processing heads and/or very powerful processing heads are provided in the areas where a lot of material is applied.

The device according to the invention can therefore also be adapted to the geometry, in particular to material accumulations and corresponding sizes of surfaces or processing areas of a component to be additively manufactured.

In this way, the device according to the invention is extremely flexible and can be adapted to almost any manufacturing requirements within certain limits.

These different configurations allow the throughput to be significantly increased, as an individual configuration of the additive manufacturing device can be optimised in terms of throughput. Conventional additive manufacturing devices, especially those that have processing heads that can be moved by means of several carriages, cannot be individually configured to the components to be manufactured, which means that there are areas in which little material is to be applied and there is overcapacity and areas in which a lot of material is to be applied and there is undercapacity.

This is explained in more detail below with reference to the technical features of the device according to the invention.

The module can comprise
a processing head,
a swivel arm with a processing head,
a carriage with a swivel arm and processing head or several swivel arms and processing heads, or
a rail with one or more carriages and rails with a swivel arm and processing head or several swivel arms and processing heads.

Furthermore, one or more of the following settings on the additive manufacturing device can be changed by exchanging one or more modules:
rail devices at different positions, in particular at different distances from each other, in a processing chamber,
different rail systems,
different types of carriages,
different types of swivel arms, in particular with regard to degrees of freedom and/or length of the arms,
a different number of processing heads per rail device, in particular a corresponding number of swivel arms and carriages,
different types of processing heads,
   wherein the control device is set up and designed to control these components so that the device can be converted accordingly for manufacturing different components and/or different areas of components.

Furthermore, a module can have an internal or external identifier. An external identifier is an identifier that is read by an external reader that is used when installing the modules. An internal identifier is an identifier that is automatically read by a reader integrated in the additive manufacturing device. An internal identifier can be in the form of a barcode or an RFID chip or a type designation stored in a semiconductor memory, for example. An external identifier can, for example, be in the form of a barcode or an RFID chip or the like. The identifier comprises either the module parameters or a code with which an automatic assignment to the module parameters is possible, wherein the corresponding module parameters can be automatically loaded into the control device or, if they are already present there, can be automatically selected.

Different module parameters for different modules may be stored in the device, wherein the module parameters may be provided internally or externally, for example with an internal or an external database or online or in connection with the modules themselves or the like.

By providing a corresponding identifier for the modules, the device recognises which modules are currently installed and which properties they have (e.g. length of the swivel arms or traversing speed or linear acceleration of the carriage or rotational acceleration and/or rotational speed of the swivel arms) in order to convert the device with a different configuration or a different arrangement and/or number of modules according to the processing requirements of a component to be manufactured.

The module parameters contain, for example, information about the length of the swivel arms, about the light intensity or temperature of a processing head, in particular a processing head for melt application, and/or about a traversing speed or acceleration of the carriages and also about a possible arrangement of the rail device at different heights orthogonal to the building platform in a Z direction or also a distance between two rails parallel to the surface of a building platform in the X or Y direction.

The control device can comprise two components. A control device is a production control unit that controls the production process with a 3D printer or the device for additive manufacturing of components.

Another component of the control device is a planning control unit, which creates one or more production processes and/or one or more configurations of the 3D printer.

According to a further aspect of the present invention, a planning control unit is provided for automatically generating a production process plan for manufacturing a specific component by means of a device for the additive manufacturing of components, in particular a device for the additive manufacturing of components shown above.

The planning control unit is set up and designed to create at least one production process on the basis of CAD data or a construction plan of the component to be manufactured.

This planning control unit is characterised by the fact that the planning control unit is set up and designed so that several production processes can be created in which different configurations of the device for the additive manufacturing of components are used by means of different module parameters, so that one of the production processes can be selected with regard to the parameter production times and/or quality.

This means that the planning control unit can analyse the CAD data or the construction plan of a component to be manufactured. Based on this analysis, the configurations of the additive manufacturing device can then be adapted by specifying certain modules.

Accordingly, the planning control unit can analyse the component to be manufactured and output an optimal configuration in order to automatically generate a production process for manufacturing a specific component using a device for additive manufacturing of components.

Additionally, and/or alternatively, the planning control unit can also create several production processes with different configurations of modules based on the CAD data and then automatically select a production process. The configurations used here are selected in advance by means of a plausibility check, as an exact analysis is sometimes very time-consuming and different production processes with different configurations also show different advantages, so that it is not generally possible to say which configuration and which production process is best. This depends on the specific application. The material to be used can also be varied, which leads to a further degree of freedom in the analysis and optimisation. The production process chart can also be selected manually on the basis of production process charts that have been created.

For automatic selection, the planning control unit can be set up and designed to automatically select a production process according to predetermined parameters.

For example, a short production time can be advantageous for high quantities or high machine utilisation, especially if no high demands are placed on the quality of the component to be produced. This means that either modules with several or a high number of processing heads and/or long or short swivel arms can be provided. In addition, processing heads with different light intensity or power or which generate different temperatures in the powder bed can also be provided in order to melt larger processing areas or smaller processing areas.

As a general rule, slower travel speeds for the carriages and shorter swivel arms in particular enable higher product quality, whereas longer swivel arms and higher travel speeds enable lower product quality.

The planning control unit can also store which modules are available in the device in order to determine which module configurations are possible.

In this way, it is possible to clearly determine which modules and how many modules or which module configuration is best suited for manufacturing a component.

The module parameters can include
a different number and/or
a different type of swivel arm, in particular with regard to a length and/or a swivelling range, and
a different type and positioning of rail devices in a processing chamber, in particular with respect to an X or Y direction parallel to a building platform and preferably in a Z direction and thus a height orthogonal to the building platform and/or
a different type of carriage, in particular with regard to structural design or geometry, or travelling speed, and/or a different type of processing head, in particular with regard to light intensity/power or temperature, and/or
a different number of processing heads per rail device.

Furthermore, different control parameters, comprising different travel speeds or accelerations for carriages and swivel arms and/or different printing speeds and/or different intensities or temperatures for the processing heads, can be stored in the control device and in particular in the production control unit or in the planning control unit, which can be selected automatically and/or manually on the basis of the components used, in particular the modules of the device and/or on the basis of construction plans for components and/or on the basis of production process charts or on the basis of a production process chart.

In particular, it may be provided that modules with a larger number of carriages per rail device have shorter swivel arms, wherein modules with a lower number of carriages per rail device have longer swivel arms.

Preferably, it can be provided that two or more rail devices can be moved together, in particular parallel to the building platform and/or orthogonal to the building platform.

This means, for example, that for areas or levels of components that have a large processing area, the rail devices can be spaced further apart parallel to the building platform and then moved closer together in areas with a greater accumulation of material or a higher component density parallel to the building platform in order to arrange more processing heads in a particular area.

The rail devices can also be movable in height in a Z-direction orthogonal to the building platform so that the corresponding swivel arms of neighbouring modules are arranged one above the other in the Z-direction and do not collide when moving. The swivel arms can also be arranged at different heights on the carriages in order to avoid a collision of swivel arms of neighbouring carriages.

In a preferred embodiment, the length of a swivel arm of a module can be changed automatically by means of an adjustment device, for example by means of a linear drive. This change in length can, for example, only be carried out during pauses in which the configuration of the additive manufacturing device is changed or can also be changed during normal operation.

Such an automatic change can be made automatically for different layers, wherein an individual configuration is also defined for the respective layers or groups of layers when the production process is created, insofar as this can be changed automatically.

The modules can also be exchanged automatically. The modules can be stored in a module magazine for this purpose and automatically exchanged using an exchange robot.

An automatic change can also be realised in combination with the automatic adjustment of the length of the swivel arms or the automatic exchange of modules or, as an alternative, by automatically moving the rails on which the carriages are mounted.

By adjusting the length of a swivel arm, for example, long swivel arms can be changed to short swivel arms during operation (dynamic), so that when two rail devices of neighbouring modules are arranged closer to each other, it is possible to prevent the processing heads or the swivel arms of the modules from touching each other. With short swivel arms, only a smaller area around the rail can be covered (coverage area). However, shorter swivel arms allow for more precise positioning compared to longer swivel arms. In addition, at least two or more rails on which short swivel arms are mounted can be arranged very close to each other, providing a high density of processing heads.

The device can be converted to produce different components and/or different areas of components by removing, adding or completely replacing modules.

According to the above embodiments, a different number of modules can be arranged in predetermined positions in the device. The modules may be connected via coupling devices to a power source and the control device and preferably to a light source.

The device can have a processing chamber, one or more building platforms and at least one material feed device.

In addition, at least one distance sensor can be provided, preferably for electro-optical distance measurement, in order to optically monitor the position of the processing heads in the X and/or Y direction parallel to the building platform and/or in the Z direction orthogonal to the building platform.

This ensures that neighbouring processing heads do not come into contact with each other during processing. Damage to the components of the device can therefore be safely and reliably avoided.

Furthermore, according to the invention, a method for calculating an optimum configuration of a device for additive manufacturing of components, in particular of a device disclosed above, is provided. Such a method comprises the following steps:
Read in CAD data of a component to be manufactured,
Determining the local work requirements in the individual layers, and
Determining an optimum configuration according to the processing requirements of all layers of a component to be manufactured.

Thus, according to the invention, a simple method is provided in which only CAD data is read in and an optimum configuration of modules is then determined on the basis of this CAD data in accordance with a processing requirement for all layers.

In this way, a user only has to read in a CAD plan and the system then automatically outputs the modules with which a device must be equipped in order to produce a component with an optimum configuration of modules in terms of quality and/or processing time and/or quantity. The device can then simply be converted accordingly.

Optimum configuration can be achieved by
a large number of processing heads are assigned to printing areas with a large accumulation of material, and/or by
print areas with a large accumulation of material are assigned short swivel arms, in particular in order to be able to arrange several processing heads in this area, and/or by
a small number of processing heads is assigned to print areas with small surfaces, and/or by long swivel arms can be assigned to printing areas with small surfaces.

With processing heads that are arranged on shorter swivel arms, a higher accuracy and therefore a higher quality of a component can be produced in this area.

In addition, processing heads with shorter swivel arms can be arranged in a higher density above a corresponding processing area or above corresponding processing areas.

Processing heads with longer swivel arms, on the other hand, allow a larger travel range with regard to the building platform and usually lead to lower product quality, as they can be controlled less precisely.

Thus, by providing processing heads with longer swivel arms, a larger processing area of the building platform can be covered, so that fewer processing heads are required to produce a component.

Furthermore, according to the invention, a method for additively manufacturing components, preferably by means of selective melting or sintering, is provided, in particular with a device as described above. The method comprises the following steps:
Storing module parameters that define predetermined properties of a module in a control device,
Control of different modules by means of the control device using the module parameters, in particular without any further set-up procedure.

The advantages of this process are analogous to the advantages described above with reference to the device for additive manufacturing of components.

In addition, according to the invention, a method for generating a production process plan for manufacturing a specific component by means of a planning control unit for a device for additive manufacturing of components is provided. The method comprises the following steps
Input of CAD data of the component to be manufactured,
Creation of at least one production process plan using the optimisation system based on the CAD data of the component to be manufactured,
Defining different configurations of the modules of the device for additive manufacturing of components, and based on this,
creating one or more production process charts, wherein the production process charts are based on different module parameters of the additive manufacturing device, and
Selecting a production process based on production time or throughput and/or product quality, wherein the production process and/or the appropriate or determined configuration is output.

The advantages of this method are analogous to the advantages described above with reference to the planning control unit according to the invention.

Furthermore, a different configuration can cause a change in the modules and thus a change in the application speed in certain areas, wherein this change in the application speed is based on a change in the arrangement or positioning of the processing heads and the processing areas assigned to them and/or a change in the number of processing heads in different areas.

This can mean, for example, an arrangement of the processing heads and the processing areas assigned to them. This can also mean a different number or density of processing heads in different areas. In addition, a completely different module configuration and thus a different number and a different arrangement and/or the provision of other modules can also be provided.

Furthermore, according to the invention, a device for the additive or generative manufacturing of components according to a further embodiment is provided, preferably by means of selective melting or sintering, in particular by means of a powder bed based laser beam fusion process (LPBF; Laser Powder Bed Fusion), which has a control device. This device also operates in accordance with the principles of the present invention described above.

The device in turn comprises a plurality of processing heads for directing a light beam onto a processing area, wherein the processing heads are each arranged on swivel arms, which in turn are arranged on a carriage that can be moved along a rail device.

The present invention is characterised in particular by the fact that the control device is set up and designed to control the device
with rail devices at different positions in a processing chamber, and/or
with different rail systems, and/or
with different types of carriages, and/or
with different types of swivel arms, in particular with regard to degrees of freedom and/or length of the arms, and/or
with a different number of processing heads per rail device, in particular with a corresponding number of swivel arms and carriages, and/or
with different types of processing heads so that the device can be converted to produce different components and/or different areas of components.

The fact that the control device is set up and designed to be able to control different components of the device accordingly provides a device for additive manufacturing that can be adapted accordingly to the geometry, in particular to material accumulations and the corresponding sizes of the surfaces of a component to be additively manufactured.

In this way, the device according to the invention is extremely flexible and can be adapted within certain limits to components of almost any size and design.

In the context of the present invention, different types of swivel arms are understood to mean that they can have different degrees of freedom and/or arms of different lengths. The degrees of freedom relate in particular to a swivel radius or swivel angle range of the swivel arms.

Furthermore, the device can have a light source for generating a light beam, wherein the processing head or heads are either coupled to the light source with a beam guide, so that the light beam is guided to the processing head, or the light source is arranged directly on the processing head, so that a light beam can be directed from the processing head to a processing area, wherein the processing head can be movably mounted, so that the light beam can be directed to different points in the processing area.

The processing heads can be designed as print heads or smoothing heads.

In the context of the present invention, an additive manufacturing process is understood to mean the layering or layer-by-layer construction of a three-dimensional component using a powder bed, a powder feed or also a wire feed, which serve as the starting material and are melted by means of a laser beam, electron beam or plasma or electric arc. Accordingly, the generative manufacturing processes mentioned in the introduction to the description (3D printing: Melting and solidification (laser engineered net shaping (LENS), as direct metal deposition (DMD) or as laser additive manufacturing (LAM)), localised sintering or melting, (laser sintering (SLS)) metal laser sintering (DMLS), metal laser sintering (IMLS), electron beam melting (EBM), powder bed based laser beam fusion laser powder bed fusion (LPBF) or laser cladding) for carrying out the process according to the invention.

According to a preferred embodiment of the present invention, a rail device with two or more carriages and one processing head per carriage forms a module, wherein a different number of modules can be arranged in predetermined positions in corresponding module holders in the processing area.

By providing the corresponding module holders, the density of the modules can be increased or decreased according to the size of a component and/or the material accumulation of a component in a certain area in order to be able to additively manufacture a corresponding component quickly, effectively and with high quality.

The module holder can have a holder for holding a rail device, which is preferably arranged on two diametrically opposite sides of the processing area.

The fact that a corresponding holder is provided to hold a rail device means that the corresponding modules can be easily inserted or coupled into the device and can be removed again just as easily.

In principle, the modules of the device can be replaced manually. The holders can then, for example, have quick-action clamping devices or the like for fixing the modules. Alternatively, however, the modules can also be changed automatically using a robot arm or replacement robot, particularly if the device is used in larger production lines and if differently dimensioned components are to be manufactured during ongoing production.

The rail devices are preferably all of the same type or essentially the same type. This means that the rail devices can be arranged in each of the module holders or the corresponding holders and exchanged flexibly. This can also be advantageous in series production, for example, if a module or a corresponding component of a module is only partially functional or no longer functional.

Preferably, two or four carriages can be arranged on the rail devices. However, within the scope of the present invention, it is also possible for at least two or three or four or at most five or six or seven or eight or nine or ten processing heads to be arranged on a rail device.

The holders of the module holders can be arranged at the same distance from each other. Preferably, these are arranged in a fixed position in the device. According to an alternative embodiment, it can also be provided that two or more module holders are arranged on a corresponding traversing device in order to move two or more modules individually or together.

The distance between two neighbouring module mounts is approximately 5 cm or at least 4 cm or 5 cm or 6 cm and a maximum of 7 cm or 8 cm or 9 cm or 10 cm or 15 cm or 20 cm or 25 cm or 30 cm.

The modules can therefore be arranged in the module holders with the same and/or different spacing.

The rail devices or modules are preferably spaced in such a way that the cover areas overlap neighbouring rail devices.

Furthermore, the modules can be interchangeable, wherein different modules with different processing heads and/or a different number of processing heads and carriages are held in a magazine. The modules can thus be held in a type of tool changing device, wherein these can be exchanged, preferably manually, as already shown above, but also automatically, for example by means of a robot device.

It can also be provided that modules with a higher number of carriages have the corresponding processing heads with shorter swivel arms, wherein modules with a lower number of carriages have the corresponding processing heads with longer swivel arms.

In this way, it is possible to provide a higher number of carriages with corresponding processing heads in areas of a component to be produced with a larger accumulation of material and/or a larger component surface without the corresponding swivel arms obstructing each other or forming overlapping swivel areas.

Coupling devices can be provided on the modules and preferably also on the corresponding module holders, via which the modules are connected to a power source and the control device and preferably at least one light source.

One or more laser devices or light sources can be provided to generate a laser beam for all processing heads. The laser device can then be connected to each individual processing head with a light guide, for example. In this case, it may be provided that a corresponding power line, possibly with a data line, is arranged in the rail device or forms the rail device so that the rail device can also be used to transport power.

Alternatively, a corresponding laser device can also be arranged directly on the respective processing head.

Different travel speeds for the carriages and/or the swivel arms and/or different printing speeds and/or different temperatures for the processing heads can be stored in the control device, which can be selected automatically and/or manually based on the components used, in particular the modules of the device and/or based on construction plans of the components to be produced.

In this way, the device according to the invention can be variably adapted to differently dimensioned components and is flexible in its area of application.

Furthermore, the control device can be set up and designed to use construction plans for different components to select which components, in particular modules of the device, are required for production and then display them accordingly.

In particular, at least one distance sensor can be provided, preferably for electro-optical distance measurement, in order to optically monitor the position of the carriages and/or swivel arms and/or processing heads. This is described in more detail below.

The device can have at least one processing chamber, at least one building platform and at least one material feed device.

The material feed device is preferably a corresponding feed device, e.g. a supply cylinder with an application device (scraper), for a powder bed process. Alternatively, a wire feeder could also be provided.

Furthermore, according to the invention, a method for calculating an optimal configuration of a printing device is provided. This method comprises the following steps:
Read in component data,
Determining the local work requirements in the individual layers and determining an optimum configuration according to the processing requirements of all layers or the layers of a component to be additively manufactured.

An optimum configuration is understood to be a configuration for forming a component based on its geometry or material accumulations.

With the method according to the invention, it is possible to determine the local work requirement in the individual layers using the component data. Subsequently, an optimum configuration can be selected according to the processing requirements of all layers or a corresponding structure, in particular with regard to the components of the device, in order to form the component as efficiently as possible. The appropriate modules are then selected in order to produce a component as quickly, safely and reliably as possible and with high quality.

The optimum configuration can be achieved by
a large number of processing heads can be assigned to printing areas with a large accumulation of material, and/or by
short swivel arms are arranged in printing areas with a large accumulation of material, and/or by a large number of processing heads can be assigned to print areas with a large surface area, and/or by
print areas with a large surface area can be assigned short swivel arms.

The processing heads can each be arranged on one of the carriages by means of a swivel arm that can be swivelled about a vertical swivel axis.

By providing several processing heads, several light beams can be directed simultaneously onto the processing area so that several points in the processing area can be melted or sintered in parallel. The processing heads are arranged on a carriage and can be moved along a traverse or rail device. This allows simple and reliable positioning of the processing heads over the processing area.

Preferably, the processing heads are each arranged on one of the carriages by means of a swivel arm that can be swivelled. By providing such swivel arms, preferably swivelling about a vertical swivel axis, for the processing heads, which are each arranged on a carriage, the processing heads can be quickly positioned at any desired location over a large section of the processing area. This section extends around the rail device, along which the respective carriage with the respective processing head can be moved in an area around the swivel axis of the swivel arm, which extends to both sides by a width corresponding to the length of the swivel arm. This section is thus strip-shaped around the rail devices with a width that corresponds approximately to twice the length of the swivel arm. This strip-shaped section is referred to below as the cover area, as the processing heads, which are arranged on the carriages of a rail device, can be arranged at any position within the cover area and can therefore apply or cover the processing area with a light beam at any position in the cover area.

The swivel arms can be designed to swivel around the vertical axis only. Such a design is very simple compared to multi-axis robot arms. Nevertheless, the processing heads can be positioned very quickly and precisely and a high throughput is achieved thanks to the parallel processing.

The swivel arms can have a length of, for example, at least 5 cm, preferably at least 10 cm or at least 15 cm, and in particular at least 20 cm. The longer the swivel arms are, the wider the cover areas are.

It may be advisable to position the processing heads only within a limited angular range of the swivel arms, as the more the swivel arms swivel the processing head away from the rail device, the less accurate the position of the processing head in the direction parallel to the rail device. The angle range can, for example, be limited to a maximum swivelling angle of 60° or 45° with respect to the rail device. With a maximum swivelling angle of 45°, the width of the cover area is reduced to the length of the swivel arm.

Along the swivel arms, the beam guidance for the respective light beam can be designed using reflector elements. This enables very light swivel arms that have a low rotational moment of inertia so that they can be swivelled quickly to any rotational position.

The swivel arms are preferably made of plastic, in particular fibre-reinforced plastic. At each end remote from the swivel axis of the swivel arm, a mirror can be provided for directing the respective light beam onto the processing area.

The beam guides can be at least partially designed as light guides. The light guide can extend from the light source to the respective processing head. However, the respective light guide can also be guided only from the light source to the swivelling end of the respective swivel arm and be arranged there with its end in such a way that the light beam couples into a beam guide along the swivel arm, which is formed by means of reflector elements. Such a design has the advantage that the swivel arm can be rotated by 360° or more without having to rotate the light guide. The end of the light guide, at which the light is coupled from the light guide into the beam guide on the swivel arm, can be arranged in a fixed position relative to the carriage to which the swivel arm is attached.

Alternatively, the end of the light guide can be arranged in a fixed position on the swivel arm so that the light beam is emitted in the direction of the free end of the swivel arm, preferably parallel to the swivel arm. A reflector element can be provided at the free end of the swivel arm to direct the respective light beam onto the processing area, such as a deflecting mirror.

The reflector element can be a parabolic mirror or a mirror with a free-form surface for focusing the light so that no optical lens is required in the beam path.

The rail devices on which the carriages are movably mounted can be arranged in a fixed position via the holders of the module holders. This is particularly advantageous in conjunction with a design with processing heads arranged on swivel arms, as such a fixed arrangement is much easier to control to avoid collisions between different swivel arms than with a device in which the swivel arms can be swivelled, the carriages can be moved along the rail devices and the rail devices themselves can be moved transversely to their longitudinal direction. In addition, with a fixed arrangement of the rail devices and swivel arms on the carriages, complete coverage of the machining area can be achieved with just a few rail devices, provided the swivel arms are not too short. Since the processing heads arranged at the free ends of the swivel arms can be very light, for example using only a small mirror, a low rotational moment of inertia can be achieved even with longer swivel arms with a length of, for example, at least 10 cm, preferably at least 15 cm, and in particular at least 20 cm.

Preferably, at least two independently movable carriages are mounted on each rail device, wherein each carriage has a processing head. More than two carriages, for example three or four carriages, can also be provided per rail device.

Preferably, several light sources are provided, each of which is assigned to one or more processing heads. The light sources are preferably lasers, in particular CO2 lasers or ND: YAG lasers. CO2 lasers are primarily used for melting or sintering plastic powder, while ND: YAG lasers are used for melting or sintering metal powder. A CO2 laser of this type has a light output of 30 W to 70 W and an ND: YAG laser of 100 W to 1,000 W and more. The light sources can also be light-emitting diodes, in particular super-luminescent light-emitting diodes, and/or semiconductor lasers.

By providing several light sources and several processing heads, which can be positioned independently of each other in the processing area, it is possible for powder to be melted or sintered simultaneously at several points in the processing area in order to produce a 3d component. This simultaneous melting or sintering of the powder significantly increases the production speed of generative manufacturing with the present device compared to conventional devices. Even if the processing heads remain at the individual points for slightly longer, a high production speed can be achieved. This makes it possible to use light sources with comparatively low light output. This significantly reduces the cost of the device.

A multiplexer can be provided to distribute the light beam of one of the light sources to different beam guidance. Such a multiplexer is preferably useful for very powerful light sources with which the powder can be melted or sintered with short pulses. The device preferably has a powder bed in the processing area, in which powder can be located, which is selectively melted by means of the light beams.

The powder can be a metal powder or plastic powder.

The individual swivel arms can be arranged at different heights to avoid collisions when moving the swivel arms.

The individual light sources can be designed in such a way that they emit light beams with different frequencies or different frequency ranges and/or different intensities. This allows the selective melting or sintering process to be individually controlled. This makes it possible, for example, to control the porosity of the product manufactured in this way.

The light beams can also be focused to different degrees on the processing area. The focusing can be adjusted, for example, by means of a lens and/or a height adjustment of the processing heads.

With the device according to the invention, powder can be melted or sintered simultaneously at several points in a powder bed.

An inert gas atmosphere can be formed throughout the device, in particular a nitrogen and/or argon atmosphere. The use of an inert gas atmosphere can prevent oxidation of the powder or the component during component production. When forming and maintaining the inert gas atmosphere, it is possible to filter dirt particles from the inside of the device in a simple manner.

Preferably, an optical system, in particular a zoom optical system, is provided to change the focusing of the emitted light beam. The focusing of the light beam can be easily adapted to different distances from the processing area. At the same time, the energy input and the irradiated area can be changed by adjusting the focus.

According to a further aspect of the invention, at least one distance sensor is provided for preferably electro-optical distance measurement. The distance sensor can be arranged at or on the movable component and measure the distance to another object, or the distance between the sensor and the other object. However, it is also possible that the distance sensor is arranged on another object and measures the distance to the moving component. In this way, the distance between the moving component and another object can be measured and determined at any time. The data recorded by the distance sensor or sensors are processed accordingly by the control device according to the invention.

The distance sensor is preferably arranged in a fixed position in order to measure the distance between the sensor and the moving component. In this way, the distance between a fixed point and the moving component can be measured and determined at any time. The moving component can have a reference object, wherein the distance sensor detects the reference object and measures the distance to the reference object. For example, a reflector, in particular a prismatic reflector, can be used as a reference object. The distance sensor can be swivelled so that it can be aligned with the reference object.

The distance can be measured by means of triangulation and/or measurement of the phase position and/or measurement of the travel time. A laser beam is emitted when measuring distance by measuring the phase position. The phase shift of the reflected laser beam or its modulation in relation to the emitted beam depends on the distance. This phase shift can be measured and used to determine the distance travelled. Distance measurement by measuring the phase shift is highly accurate. In laser triangulation, a light beam is focused on the measurement object and observed with a camera located next to it in the sensor, a spatially resolving photodiode or a CCD line. If the distance of the measurement object from the sensor changes, the angle at which the light spot is observed also changes and therefore the position of its image on the photoreceiver. The distance of the object from the laser projector is calculated from the change in position using the angle functions. Distance measurement using triangulation is simple, inexpensive and yet very precise. When measuring the travel time, a light pulse or a modulated light beam is emitted. The travel time is the time it takes for the light beam to travel from the source to a reflector, usually a retroreflector, and back to the source again. By measuring this travel time, the distance between the source and the object can be determined using the speed of light. Alternatively, or additionally, sensors that can scan lines or surfaces or planes or perform spatial measurements, such as stereo cameras for three-dimensional localisation of one or more objects, can also be used to measure distances. Such sensors do not need to swivel due to their large receiving region.

Instead of optical sensors, other sensors can also be used, such as ultrasonic sensors or sensors that determine the distance using the propagation time of radio waves.

The control and regulation device can thus be designed in such a way that the movable component can be moved to a target position depending on the measured distance between the distance sensor and the movable component. The use of distance sensors together with a control and regulation device enables the use of a cost-effective and particularly lightweight movement device for moving the movable component or the carriages. A cost-effective and lightweight movement device has low positioning accuracy, but can be moved particularly quickly. The position of the moving component can be controlled depending on the distance between the moving component and the distance sensor. The closer the moving component approaches its target position, the slower the component can be moved. In this way, it can be ensured that the moving component can reach the target position exactly. The movement device can be simple and, above all, lightweight and favourably designed, as the precision of the movement and positioning is ensured by the distance measurement and closed-loop control. Proportional controllers, so-called P-controllers, proportional-integral controllers, so-called PI-controllers, and/or proportional-integral-differential controllers, so-called PID-controllers, can be used as controllers in the control loop.

Two, preferably three, distance sensors can be provided to measure the distance between the distance sensors and the moving component in order to determine the spatial position of the moving component. If the moving component is only moved in one plane, i.e. in two dimensions, its position can be determined exactly by measuring the distance from two distance sensors. By measuring three distances between the moving component and three fixed distance sensors, the spatial position of the moving component can be determined exactly in three dimensions. If the moving component is only moved in one direction, one sensor can also be sufficient for distance measurement.

In a preferred embodiment, more than three distance sensors and at least two movable components are provided, wherein each movable component can be detected in any position by at least three distance sensors for distance measurement. A distance sensor can be used to measure the distance between itself and both moving components. Depending on the positions of a first movable component, a distance sensor can be covered by this first movable component in such a way that distance measurement to a second movable component is not possible. In such a case, the distance measurement can be carried out via another distance sensor that has direct optical access to the second moving component. This makes it possible to use different or the same distance sensors for each position determination of a moving component by distance measurement.

The distance sensors can be arranged in a fixed position in the device, for example connected to the foundation of the device via a carrier. The distance sensors can determine the position of the surface of the powder bed using a distance measurement and then determine the position of a moving component, such as a processing head, using another distance measurement. The processing head can be moved to a target position depending on the position of the powder bed, i.e. the height of the powder bed, in order to set the required distance between the processing head and the surface of the powder bed. One or more processing heads can be moved to their target position using the control and regulation device described above. It is also possible that one or more distance sensors are connected to or arranged on a processing head and the distance between the processing head and the surface of the powder bed is determined in order to subsequently move the processing heads to a target distance from the surface of the powder bed.

Instead of the position of one or more processing heads, the position of a rail device or another component of a direction of movement, such as a carriage, can also be determined and positioned relative to the surface of the powder bed. For this purpose, one or more distance sensors can be connected directly to the rail device and measure the distance to the surface of the powder bed.

A scraper can also be positioned in the same way, for example relative to the powder bed surface. At least one distance sensor can be connected to the scraper or arranged in a fixed position in the device for this purpose.

Three distance sensors can be permanently assigned to each moving component for distance measurement. The same three distance sensors can be assigned to the same moving component for each distance measurement. However, it is also possible for the distance sensors to be reassigned to a component for each distance measurement. In this way, different distance sensors can be partially or completely assigned to each moving component for each new distance measurement than for a previous distance measurement.

The embodiments of the invention described above can be combined with each other as required. The aspects of the invention described above are not limited to the combinations of inventive features specified by the selected paragraph formatting.

Further features of the present invention are apparent from the following description of the invention with reference to the drawings and the drawings themselves. All of the features described and/or illustrated form the subject matter of the present invention, either individually or in any combination, irrespective of their summarisation in the claims or their relationship to one another.

The present invention is described in more detail below with reference to an exemplary embodiment shown in the figures. These show in

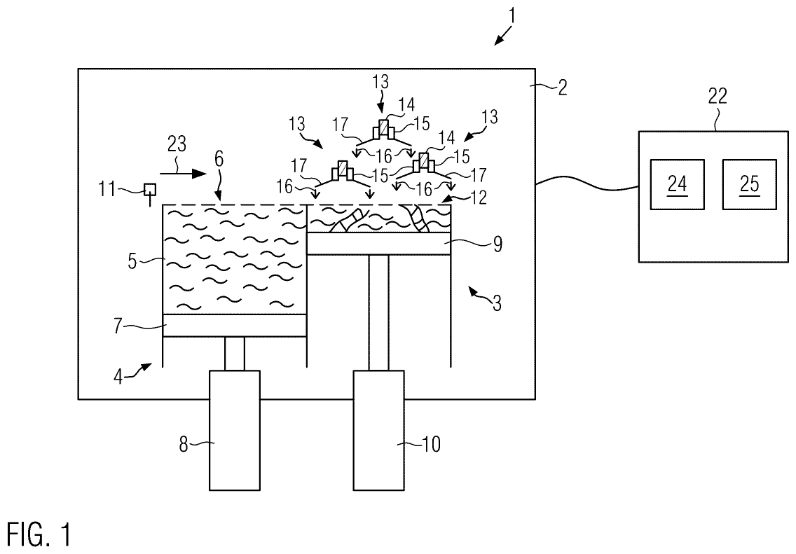

FIG. 1 is a schematic side view of a device for additive manufacturing according to the invention,

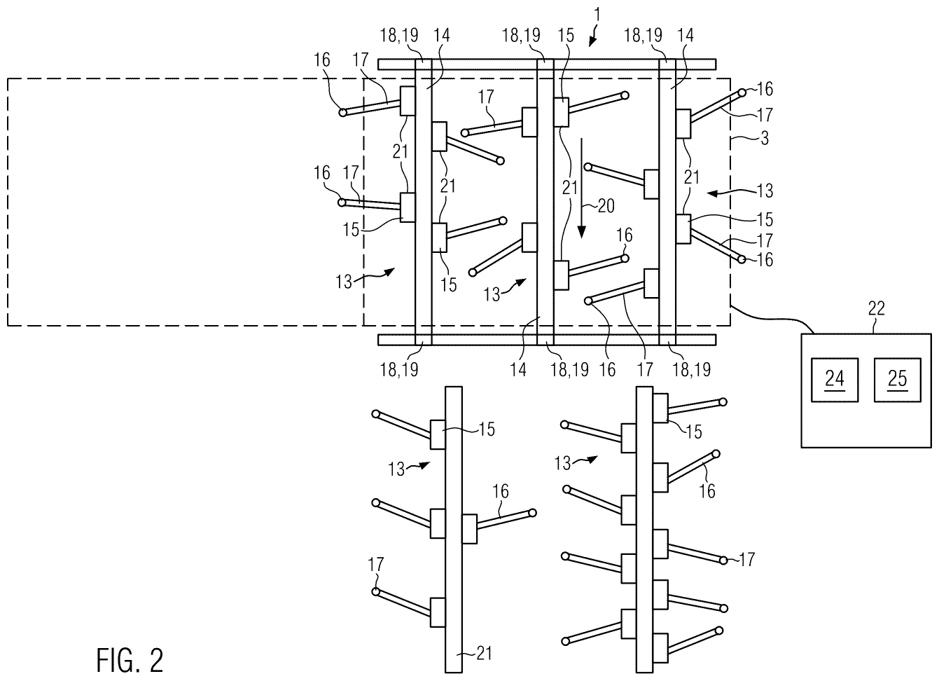

FIG. 2 is a schematic top view of the additive manufacturing device, and

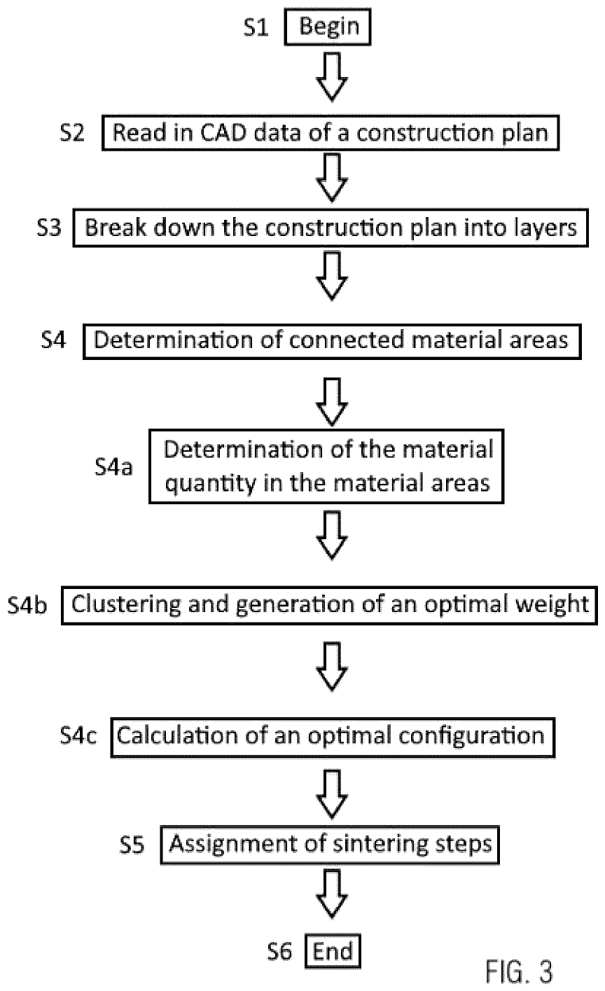

FIG. 3 shows a process for creating a production process chart schematically in a flow diagram.

According to an embodiment example, a device for the additive manufacturing of components is provided. This is briefly referred to as a “3D printer” 1.

The 3D printer 1 comprises a closed processing chamber 2.

A production device 3 and a storage device 4 are arranged adjacent to each other in the processing chamber 2.

The supply device 4 comprises a supply container 5 in which a powder 6 is stored. A bottom wall 7 of the supply container can be moved in a vertical direction by means of a supply piston cylinder unit 8.

In this way, the powder 6 held in the supply container can be transported upwards in a vertical direction.

The production device 3 has a building platform 9. The building platform 9 can also be moved in a vertical direction by means of a production piston cylinder unit 10.

Furthermore, the 3D printer 1 has a scraper 11 with which the powder 6 can be applied from the storage device 4 in a horizontal direction 23 onto the building platform 9 of the production device 3. In this way, a powder bed 12 can be formed on the building platform 9.

In the area of the building platform 9, three modules 13 are provided in the present design example, arranged parallel to each other in a top view.

Such a module 13 comprises a rail device 14, several carriages 15 with corresponding processing heads 16, wherein the processing heads 16 are connected to the carriages via swivel arms 17.

The modules 13 are fixed via corresponding module holders 18. To fix the modules 13 in the module holders 18, the module holders have corresponding brackets 19.

The carriages 15 have drive units (not shown) with which the carriages 15 and thus the processing heads 16 can be moved along a longitudinal direction 20 of the rail devices.

The carriages 15 and the processing heads 16 are connected to a control device 22 via a coupling device 21.

Different travelling speeds for the carriages 15 and/or the swivel arms 16 and/or different printing speeds and/or different temperatures for the processing heads 17 can be stored in the control device 22, which can be selected automatically and/or manually on the basis of the components used, in particular the modules 13 of the device 1 and/or on the basis of construction plans of the components to be produced.

Furthermore, the control device can be set up and designed to use construction plans for different components to select which components, in particular modules of the device, are required for production and then display them accordingly.

The control device 22 comprises two components, a production control unit 24 which controls the production process with the 3D printer 1 and a planning control unit 25 which creates one or more production process charts and/or one or more configurations of the 3D printer 1.

The planning control unit 25 carries out a procedure for creating a production process (FIG. 3), which begins with the step S1.

In step S2, a construction plan in the form of CAD data is read in.

In step S3, the construction plan is broken down into layers that correspond to the layers with which the component can be produced in the 3D printer 1.

In step S4, contiguous material areas are determined in the individual layers, which contain material from the component. Closely neighbouring material areas can be combined into a common material area. This grouping of the material areas within a layer is carried out using a cluster method, which is why these summarised material areas can also be referred to as layer clusters.

In step S5, sintering steps with a specific processing head 16 are assigned to the individual points of the material areas. This assignment is carried out according to predetermined rules, wherein preferably several adjacent processing points are processed consecutively. These rules can be based on different processing principles, such as those from the as yet unpublished German patent application DE 10 2022 107 263.0, wherein the material is sintered line by line, wherein the lines are initially created at a distance from each other, wherein after a certain time the area between the lines sintered at a distance is also sintered if this corresponds to the construction plan. If a sintering processing step is assigned to all material points in all layers, then the production process chart is complete and the process is ended with step S6.

This method explained above can be modified according to the invention in such a way that after step S4, a step S4a is carried out, with which the contiguous material areas or layer clusters are each assigned a value that corresponds to the amount of material contained therein. The amount of material is proportional to the number of sintering processing steps required to create this area. A sintering processing step is an irradiation with a laser beam for a certain period of time or cycle time. The irradiation can also be continuous, wherein each irradiation duration for a cycle time represents a separate sintering processing step.

The need for sintering processing steps can thus be assigned to the individual areas. This requirement is a type of optimisation weight, which indicates whether more or fewer processing heads 16 should be assigned to the respective area. These optimisation weights are calculated for each layer and assigned to a specific material area or layer cluster.

In a step S4b, the superimposed material areas or layer clusters are clustered in the vertical direction (=Z direction), wherein the individual superimposed material areas or layer clusters do not have to match exactly. The optimisation weights are averaged for the individual clusters so that a requirement for processing heads 16 can then be assigned to the respective cluster areas on the basis of the averaged optimisation weights.

In step S4c, an optimised configuration of the 3D printer is calculated based on the respective demand assigned to the clusters, wherein the number of processing heads 16 is distributed as evenly as possible in proportion to the averaged optimisation weights.

The following steps S5 and S6 are then carried out with this configuration.

Another optimisation method can also be used to determine an optimum configuration in accordance with steps S4a to S4c.

In a further modification of the invention, several groups of layers are clustered separately, wherein an individual optimal configuration of the 3D printer is then determined within a group of layers. Such an optimisation of several groups of layers is particularly useful if the configuration of the 3D printer 1 can be carried out automatically, for example by the rail devices 14 being automatically movable and/or the swivel arms 17 being automatically adjustable in length and/or the modules being automatically interchangeable. When executing the production process plan, this then results in the groups of layers each being printed with a specific configuration in the 3D printer 1, wherein the printing process is briefly interrupted after each group of layers in order to change the configuration, for example by moving the rail devices according to the new configuration and/or automatically adjusting the lengths of the swivel arms and/or automatically or manually exchanging the modules.

In a further alternative embodiment, an individual configuration can be provided in each layer, i.e. that the position of the rail devices 14 and/or the length of the swivel arms 17 can be changed in each layer. In this embodiment, the change in the position of the rail devices 14 and the changes in the length of the swivel arms 17 may also be considered an integral part of the change in the position of the processing heads 16 in the processing chamber 2 above the powder bed 12.

The production control unit 24 controls the production process according to the specified production process. Here, as is basically known from 3D printing, components are built up layer by layer, wherein one or more laser beams are directed onto the powder bed 12 by means of the processing heads 16 in order to melt the powder 6 contained therein. According to the production process plan, the movements of the processing heads 16 and the switching on and off of the corresponding lasers as well as the application of powder layers in the powder bed 12 are controlled.

If the 3D printer 1 is configured automatically, this is also controlled by the production control unit 24. In this case, the rail devices 14 can be moved automatically and/or the length of the swivel arms 17 can be changed automatically and/or the modules 13, which are preferably stored in a module magazine (not shown), can be exchanged automatically.

A corresponding replacement robot can be provided for replacing the modules 13, wherein in this case the modules 13 preferably each comprise a carriage 15 with a swivel arm 17 and a processing head 16.

The modules 13 are designed in such a way that they can be easily decoupled from the rail device 14 by the replacement robot and replaced by another module 13, which is coupled to the rail device 14. The position of an exchanged module 13 is calibrated, for example, by moving the module 13 to an end position on the corresponding rail device 14, at which the module 13 abuts against a predetermined stop.

Furthermore, according to the invention, a method for additively manufacturing components, preferably by means of selective melting or sintering, is provided, in particular with a device as described above. The method comprises the following steps: Storing module parameters that define predetermined properties of a module in a control device, Control of different modules by means of the control device using the module parameters without any further set-up procedure.

In addition, according to the invention, a method for generating a production process plan for manufacturing a specific component by means of a planning control unit for a device for additive manufacturing of components is provided. The method comprises the following steps Input of CAD data of the component to be manufactured, Creation of at least one production process plan using the optimisation system based on the CAD data of the component to be manufactured,

Defining different configurations of the modules of the device for additive manufacturing of components, and based on this,
creating a plurality of production process charts, wherein the production process charts of different module parameters of the additive manufacturing device are defined, and
Selecting a production process based on production time and/or product quality and/or quantity, wherein the production process and the appropriate configurations are output.

Furthermore, a different configuration can cause a change in the components, in particular the modules, an area-by-area change in the application speed, wherein this change in the application speed is a change in the arrangement or positioning of the processing heads and the processing areas assigned to them and/or a change in the number of processing heads in different areas.

This can mean, for example, an arrangement of the processing heads' print buttons and the processing areas assigned to them. This can also mean a different number or density of print heads in different areas. In addition, a completely different module configuration and thus a different number and a different arrangement and/or the provision of other modules can also be provided.

Furthermore, according to the invention, a method for calculating an optimal configuration of a printing device is provided. This method comprises the following steps:
Read in component data,
Determining the local work requirements in the individual layers and determining an optimum configuration according to the processing requirements of all layers or the layers of a component to be additively manufactured.

An optimum configuration is understood to be a configuration for forming a component based on its geometry or material accumulations.

With the method according to the invention, it is possible to determine the local work requirement in the individual layers using the component data. Subsequently, an optimum configuration can be selected according to the processing requirements of all layers or a corresponding structure, in particular with regard to the components of the device, in order to form the component as efficiently as possible. The appropriate modules are then selected in order to be able to produce a component as quickly, safely and reliably as possible and with high quality.

The optimum configuration is achieved by
a large number of processing heads are assigned to printing areas with a large accumulation of material, and/or by
short swivel arms are arranged in printing areas with a large accumulation of material, and/or in which a large number of processing heads can be assigned to print areas with a large surface area, and/or by
print areas with a large surface area can be assigned short swivel arms.

Further advantageous embodiments of the present invention are shown below.

The rail devices 14 are arranged parallel to each other. In the present design example, three rail devices 14 are provided (FIG. 1, FIG. 2). The centre rail device 14 is arranged slightly higher than the two outer rail devices 14.

The carriages 15 are controlled by the control device and can be moved automatically along the respective rail device 14 by means of a drive unit. A drive unit may comprise a drive belt driven by an external motor, which is coupled to the respective carriage 15. However, a drive mechanism, such as a drive wheel driven by a motor, may also be provided in the carriage 15 itself. In principle, it is also possible to drive the carriage by means of a linear motor.

The swivel arm 16 is arranged on the carriage 15 by means of a swivel joint. The swivel arm 16 is rotatably mounted with the swivel joint, preferably about a vertical swivel axis. A stepper motor is provided on the carriage 15 for rotating the swivel arm 16 about the swivel axis. The processing head 17 is provided at the end of the swivel arm 16 remote from the swivel axis.

This is formed by one end of a light guide and an optical lens arranged at the end of the light guide. The processing head 17 is arranged in such a way that a light beam guided in the light guide is emitted vertically downwards.

The light guide is made of a flexible optical fibre. The optical fibre can be a glass fibre or an optical polymer fibre, for example.

The light guide leads to a light source which is arranged at a distance from the swivel arm 18. The light source is preferably a laser, in particular a CO2 laser or an ND: YAG laser or a fibre laser. The light source can also be a semiconductor laser or a light-emitting diode, in particular a super-luminescent light-emitting diode.

An array of light sources can also be provided, with one light source for each processing head.

Further embodiments of the swivel arm are explained below, which are designed in the same way as the embodiment described above, unless otherwise stated.

In an alternative embodiment of the swivel arm 16, the light source together with the optical lens is arranged directly at the end of the swivel arm 17 remote from the swivel axis in such a way that a light beam can be emitted vertically downwards.

According to a further embodiment, a beam guide is formed from the light source to the carriage 15 by means of a light guide and along the swivel arm 16 by means of reflector elements. In the present embodiment example, the reflector elements are each designed as mirrors. However, they can also be represented by other optical elements that deflect a light beam, such as prisms or the like.

The swivel joint has a vertically extending through opening or through hole. Adjacent above the through hole, the end of the light guide 26 remote from the light source is arranged together with a coupling lens, so that the light beam generated by the light source is transmitted via the light guide and coupled from there into the through hole of the swivel joint. A first reflector element is arranged below the through hole, which deflects the light beam in such a way that the light beam is directed towards the free end of the swivel arm. The second reflector element, which deflects the light beam vertically downwards, is arranged at the free end of the swivel arm away from the swivel axis. Optionally, an optical lens for focusing the light beam can be provided in the beam path between the end of the light guide, which is arranged adjacent to the swivel joint, and the second reflector element. Instead of the optical lens 30, an objective can also be provided, with which the degree of focusing of the light beam can be changed.

The first and/or second reflector element can be shaped in such a way, e.g. as a parabolic mirror or free-form mirror, that it focuses the reflected light. This means that it is not necessary to arrange an optical lens in the beam path or an optical lens with low refractive power can be provided in the beam path.

When moving the processing head 17 by means of the swivel arm 16, the light guide is only moved along the rail device 14 with its end arranged in the carriage 15. The swivel arm 16 can perform a rotary movement that has no influence on the position of the light guide. This makes it possible for the swivel arm 16 to perform one or more complete rotations without impairing the functionality of the light guide, as it is not entrained during such a rotational movement of the swivel arm.

With such an arrangement, it is thus possible to provide a plurality of processing heads 17 each by means of a swivel arm on a carriage 15 that can be moved along the rail devices 14, wherein it is ensured that the individual light guides cannot become entangled with one another. This makes it easy to create a 3D printer 1 which has at least eight, preferably at least twelve and in particular at least sixteen processing heads, all of which can be exposed to a light beam simultaneously or virtually simultaneously.

The light sources can generate the light beam bundle in continuous mode (cw) or in pulsed mode (pw). In the case of a pulsed light source 25 with a high light intensity, it may also be expedient to assign a light source to several processing heads, wherein a multiplexer is then arranged between the light source and the respective processing heads, so that the light beam generated by the light source is clearly fed to one of the several processing heads by means of the multiplexer. The change between the individual processing heads can take place so quickly that, compared to the melting or sintering process, the change is so fast that the individual processing heads 13 coupled to this can be regarded as being exposed to a light beam virtually simultaneously.

A further embodiment of the swivel arm has a pumped laser with a light pump and a resonator as the light source, which are connected to each other via a light guide 34. The resonator comprises an active medium, which preferably consists of a solid body and which is excited or pumped by means of pumping light emitted by the light pump.

The resonator is arranged together with the optical lens directly at the end of the swivel arm 17 remote from the swivel axis in such a way that a light beam can be emitted vertically downwards. The light pump is arranged on the carriage in such a way that it does not follow the swivelling movement of the swivel arm. The light pump usually comprises one or more semiconductor lasers and a heat sink with cooling fins. The light pump is much heavier than the resonator and the optical lens. Since only the resonator and the optical lens and not the light pump 3 are moved, the rotational moment of inertia of the swivel arm 16 is low.

In this embodiment, the light pump is arranged on the carriage 15. However, the light pump can also be arranged independently or remotely from the carriage.

This embodiment can also be modified in such a way that a beam guide with reflector elements is provided instead of the light guide. In this case, the light guide can either be omitted completely or only guided as far as the carriage if the light pump is arranged away from the carriage.

Preferably, an ND: YAG laser is used as the pumped laser and one or more laser diodes with a wavelength of 808 nm are used as the light pump. However, another laser, such as a Yb:YAG laser, can also be used.

According to a further embodiment, a beam guide is formed from the light source to the swivel arm 16 by means of a light guide. The light guide is guided from the light source to the swivel arm 16, wherein the light guide is arranged with its end remote from the light source below the swivel arm 16 in the area of the carriage 15. The light guide is connected to the swivel arm 16 in such a way that the light guide is guided along the swivel arm in the area of the carriage 15 and its end remote from the light source points towards the free end of the swivel arm 16. A reflector element, which is designed as a mirror, is arranged at the free end of the swivel arm 18. However, the reflector element can also be represented by other optical elements which deflect a light beam, such as a prism or the like.

A light beam emitted by the light source is transmitted by the light guide and emitted at its end remote from the light source in such a way that the light beam is deflected along the swivel arm 16 in the direction of the reflector element, preferably parallel to the swivel arm 16. The second reflector element is arranged at the free end of the swivel arm 16, which deflects the light beam downwards onto the processing area. Optionally, an optical lens for focusing the light beam can be provided in the beam path between the end of the light guide and the reflector element. Instead of the optical lens, an objective can also be provided in order to be able to change the degree of focusing of the light beam and/or the reflector element can be curved accordingly.

With such an arrangement, a plurality of processing heads 17 can thus each be provided by means of a swivel arm 16 on a carriage 17 that can be moved along the rail devices 14, wherein it is ensured that the individual light guides cannot become entangled with one another. This makes it easy to create a 3D printer 1 which has at least eight, preferably at least twelve and in particular at least sixteen processing heads 17, all of which can be exposed to a light beam simultaneously or virtually simultaneously.

In the present embodiment example, the rail devices 14 and thus also the swivel arms 16 attached to them are arranged at different levels, so that the swivel arms 16 arranged on the centre rail device 14 cannot collide with the swivel arms 16 arranged on the outer rail devices 14. The level of the swivel arms 16 can also be designed differently if all rail devices are arranged at the same height. This can be achieved, for example, by attaching the swivel joints to the individual carriages 15 at different heights. However, the rail devices can also all be arranged in one plane.

In the embodiment example explained above, the swivel arms 16 are not adjustable in the vertical direction. Within the scope of the invention, however, it is possible either to provide a device on the carriage 15 for adjusting the vertical position of the swivel arm 16 or to make the rail devices 14 adjustable in the vertical position. This can be particularly expedient in order to create sufficient space for the movement of the scraper between the powder bed 12 and the swivel arms 16 when the powder bed 12 is being scraped by means of the scraper 11, and after the scraper 11 is again outside the area of the powder bed 12, the swivel arms 16 can be lowered in order to arrange the processing heads 17 as close as possible to the surface of the powder 6 located in the powder bed 12.

The light sources for the individual processing heads 17 can be designed identically and each generate a light beam with the same intensity and the same frequency or the same frequency range. Within the scope of the invention, however, it is also possible to provide different light sources for the different processing heads, with which light is emitted with different frequencies or frequency ranges and/or with different intensities. Light sources can also be provided with which the wavelength of the light can be tuned over a certain range. Such frequency-tunable lasers are known and usually have a semiconductor amplifier.

One advantage of the present invention lies in the fact that different areas of the powder 6 in the powder bed 12 can be exposed to light and thus heat simultaneously by the multiple processing heads 17 and can be melted or sintered at the same time. This parallelises the manufacturing process and speeds it up considerably compared to conventional 3D printers.

According to a further embodiment example, optical distance sensors are used to measure the distances between the reference elements and the distance sensors. Such distance sensors are inexpensive and have a very high resolution. They can determine the distance to the reference element by means of triangulation. In triangulation, an optical beam, for example a laser beam, is focused on the measurement object and observed with a camera, a spatially resolving photodiode or a CCD line located next to it in the distance sensor. If the distance of the measurement object from the sensor changes, the angle at which the light spot is observed also changes and therefore the position of its image on the photoreceiver. The distance of the object from the laser projector is calculated from the change in position using the angle functions. Distance measurement using triangulation is very simple and inexpensive. If the accuracy requirements are low, the radiation from a light emitting diode can also be used as a light beam.

The distance can also be measured by measuring the phase position. When measuring the phase position, an optical beam, for example a laser beam, is emitted. The phase shift of the reflected laser beam compared to the emitted beam depends on the distance. This phase shift can be measured and used to determine the distance travelled. Distance measurement by measuring the phase shift is highly accurate.

When measuring distance using the travel time, a short pulse of light, a constant beam of light or a light modulation is emitted. The pulse propagation time is the time it takes for the light beam to travel from the source to a reflector and back to the source again. By measuring this transit time, the distance between the source and the object can be determined via the speed of light.

Sensors that scan lines, surfaces or planes, such as stereo cameras for three-dimensional localisation of one or more objects, can also be used to measure distances. Such sensors do not need to swivel due to their large receiving region.

Instead of optical sensors, other sensors can also be used, such as ultrasonic sensors or sensors that determine the distance using the propagation time of radio waves.

Regardless of the type of sensor, the advantage is that the position of the processing heads can be set very precisely thanks to the control loop. This can also be used to determine the position of the processing heads that can only be moved in one plane in accordance with the first embodiment example.

For precise positioning, the actual position of the moving component, for example the processing head 17, can be detected after the start. For this purpose, the distance between the processing head 17 and the respective distance sensor can be measured. The actual position is detected by measuring the distance using the distance sensors. The actual position of the processing head can be easily determined from the three distance measurements. If the actual position corresponds to the target position, no further action is required and component production can continue.

The position of the moving component, for example the processing head 17, can be determined absolutely in space. However, the position of the moving component can also be determined relative to another component. In the latter case, the distance between the two components is determined.

The actual position of the movable component can be controlled in each spatial direction or in relation to each axis individually and successively until the target position is reached. However, it is also possible to control the position of the moving component in all three spatial directions or in relation to all axes simultaneously.

The distance sensors can be arranged in a fixed position in the processing chamber 2 of the 3D printer 1. The distance sensors can determine the position of the surface of the powder bed 12 via a distance measurement and then determine the position of a moving component, for example a processing head 17, with the aid of a further distance measurement. The processing head 17 can be moved to a target position as a function of the position of the powder bed 12, i.e. the height of the powder bed 12, in order to set a required distance between the processing head 17 and the surface of the powder bed 12. The movement of one or more processing heads 17 into their target position can thereby be carried out with the aid of the control and regulation device described above. It is also possible that one or more distance sensors are connected to or arranged on a processing head 17 and the distance between the processing head 17 and the powder bed surface is determined directly in order to subsequently move the processing heads 17 to a target distance from the surface of the powder bed 12.

If the actual position does not correspond to the target position, the position of the processing head 17 is then modified. For this purpose, a drive can be started and the traversing speed of the processing head 17 can be set depending on the distance between the actual position and the target position. The smaller the distance between the actual position and the target position, the lower the traversing speed can be selected. After a set unit of time and/or a defined distance travelled, the actual position can be recorded again and then modified if necessary. It is also possible to record the actual position continuously. In this way, a closed control loop can be created. This control makes it possible to transfer the processing head 17 exactly to a target position using a simple, inexpensive and in itself not very precise movement device. The accuracy of the positioning is determined solely by the distance measurement using the distance sensors.

### LIST OF REFERENCE SYMBOLS

1 3D printer
2 Processing chamber
3 Production equipment
4 Storage device
5 Supply container
6 Powder
7 Bottom wall
8 Supply piston/cylinder unit
9 Building platform
10 Production piston-cylinder unit
11 Scraper
12 Powder bed
13 Module
14 Rail equipment
15 Carriage
16 Processing head
17 Swivel arm
18 Module mounting
19 Bracket
20 Longitudinal direction
21 Coupling device
22 Control device
23 Horizontal direction
24 Production control unit
25 Planning control unit

1. A device for the additive manufacturing of components, preferably by means of selective melting or sintering, comprising
at least one module with a processing head for directing a light beam onto a processing area, and a swivel arm on which the processing head is arranged, and a carriage on which the swivel arm is rotatably mounted, wherein the module can be moved along a rail device, and
a control device in which module parameters can be stored or are stored, which define predetermined properties of the module, wherein the control device is set up and designed to control different modules using the module parameters, so that modules can be exchanged in the device for the additive manufacturing of components and these can be controlled by the control device, preferably without any further set-up procedure.

2. The device according to claim 1, wherein a module comprises at least one processing head, at least one swivel arm and at least one carriage, or wherein the module comprises several processing heads with corresponding swivel arms, carriages and rails.

3. The device according to claim 1, wherein a module has an identifier which contains the module parameters or an automatic assignment to the module parameters, wherein in particular different module parameters for different modules can be stored in the device.

4. A planning control unit for automatically generating a production process plan for manufacturing a specific component by means of a device for the additive manufacturing of components, according to claim 1,
wherein the planning control unit is set up and designed to create at least one production process plan on the basis of CAD data of the component to be manufactured,
wherein
the planning control unit is set up and designed such that an optimised configuration is determined on the basis of the CAD data of the component to be manufactured, and a production process plan is created on the basis of the optimised configuration, wherein
in particular a plurality of production process plans are created for different configurations of the additive manufacturing device, in which the different configurations are defined by means of different module parameters, so that one of the plurality of production process plans can be selected with regard to the parameters of production time and/or product quality.

5. The planning control unit according to claim 4, wherein the planning control unit is set up and designed to automatically select a production process according to predetermined parameters.

6. An additive manufacturing device according to claim 1 wherein the module parameters include
a different number and/or
a different type of swivel arm, in particular with regard to a length and/or a swivelling range, and
a different type and positioning of rail devices in a processing chamber, in particular with respect to an X or Y direction parallel to a building platform and preferably in a Z direction and thus a height orthogonal to the building platform, and/or
a different type of carriage, in particular with regard to structural design, and/or
a different type of processing head, in particular with regard to intensity or temperature, and/or
a different number of processing heads per rail device.

7. The additive manufacturing device according to claim 6, wherein different control parameters comprising different travelling speeds or accelerations for carriages and swivel arms and/or different printing speeds and/or different intensities or temperatures for the processing heads are stored in the production control unit and/or the planning control unit, which can be selected automatically and/or manually on the basis of the components used, in particular the modules of the device and/or on the basis of construction plans for components.

8. The additive manufacturing device according to claim 6, wherein modules with a larger number of carriages per rail device have processing heads with shorter swivel arms, wherein modules with a lower number of carriages per rail device have longer swivel arms.

9. The additive manufacturing device according to claim 6, wherein two or more rail devices are designed to be movable.

10. An additive manufacturing device of components, preferably by means of selective melting or sintering, comprising
at least one module with a processing head for directing a light beam onto a processing area, and a swivel arm on which the processing head is arranged, and a carriage on which the swivel arm is rotatably mounted, wherein the module can be moved along a rail device, and a control device in which module parameters can be stored or are stored, which define predetermined properties of the module, wherein the control device is set up and designed to control different modules using the module parameters, so that modules can be exchanged in the device for the additive manufacturing of components and these can be controlled by the control device, preferably without any further set-up procedure,
wherein the control device in which module parameters can be stored or are stored, which define predetermined properties of the module, wherein the control device is set up and designed to control different modules using the module parameters, so that modules can be exchanged in the device for the additive manufacturing of components and these can be controlled by the control device, preferably without any further set-up procedure is a production control unit and wherein this control device also comprises the planning control unit and, in this way, forms the control device.

11. The additive manufacturing device according to claim 10 wherein at least one distance sensor is provided, preferably for electro-optical distance measurement, in order to optically monitor the position of the processing heads.

12. A method for calculating an optimal configuration of a device for additive manufacturing of components, in particular for use in a device for additive manufacturing comprising at least one module with a processing head for directing a light beam onto a processing area, and a swivel arm on which the processing head is arranged, and a carriage on which the swivel arm is rotatably mounted, wherein the module can be moved along a rail device, and
a control device in which module parameters can be stored or are stored, which define predetermined properties of the module, wherein the control device is set up and designed to control different modules using the module parameters, so that modules can be exchanged in the device for the additive manufacturing of components and these can be controlled by the control device, preferably without any further set-up procedure
wherein it comprises the following steps:
Read in CAD data of a component to be manufactured (from component data)
Determining the local work requirements in the individual layers, and
Determining an optimum configuration of modules according to the processing requirements of all layers.

13. The method according to claim 12, wherein the optimal configuration is created by
a large number of processing heads are assigned to printing areas with a large accumulation of material, and/or by
printing areas with a large accumulation of material are assigned short swivel arms, and/or by a small number of processing heads are assigned to print areas with small surfaces, and/or by long swivel arms can be assigned to printing areas with a small surface area.

14. A method for additive manufacturing of components, preferably by means of selective melting or sintering, method for calculating an optimal configuration of a device for additive manufacturing of components, comprising the following steps
Storing module parameters that define predetermined properties of a module in a control device, Control of different modules according to a production process by means of the control device using the module parameters, without further set-up procedure after changing the configuration of an additive manufacturing device.

15. A method for generating a production process plan for manufacturing a specific component by means of a planning control unit for a device for the additive manufacturing of components,
Read in of CAD data of the component to be manufactured,
Creating at least one production process plan using the planning control unit on the basis of the CAD data of the component to be manufactured,
Creating different configurations of the modules of the device for additive manufacturing of components, and based on this,
creating a plurality of production process charts, wherein the production process charts are defined by different module parameters of the additive manufacturing device, and
Selecting a production process based on production time and/or product quality and/or quantity, wherein the production process and/or the appropriate configuration is output.

16. The method according to claim 15, wherein a different configuration causes a change in the components, in particular the modules, an area-by-area change in the application speed, wherein this change in the application speed is a change in the arrangement or positioning of the processing heads and the processing areas assigned to them and/or a change in the number of processing heads in different areas.

17. A planning control unit for automatically generating a production process plan for manufacturing a specific component by means of a device for the additive manufacturing of components,
wherein the planning control unit is set up and designed to create at least one production process plan on the basis of CAD data of the component to be manufactured,
wherein
the planning control unit is set up and designed such that an optimised configuration is determined on the basis of the CAD data of the component to be manufactured, and a production process plan is created on the basis of the optimised configuration, wherein
in particular a plurality of production process plans are created for different configurations of the additive manufacturing device, in which the different configurations are defined by means of different module parameters, so that one of the plurality of production process plans can be selected with regard to the parameters of production time and/or product quality.

18. The planning control unit according to claim 17, wherein the planning control unit is set up and designed to automatically select a production process according to predetermined parameters.

19. The planning control unit according to claim 17, wherein different control parameters comprising different travelling speeds or accelerations for carriages and swivel arms and/or different printing speeds and/or different intensities or temperatures for the processing heads are stored in the production control unit and/or the planning control unit, which can be selected automatically and/or manually on the basis of the components used, in particular the modules of the device and/or on the basis of construction plans for components.

20. The planning control unit according to claim 17, wherein modules with a larger number of carriages per rail device have processing heads with shorter swivel arms, wherein modules with a lower number of carriages per rail device have longer swivel arms.

21. The planning control unit according to claim 17, wherein two or more rail devices are designed to be movable.

22. The planning control unit according to claim 17, wherein the control device in which module parameters can be stored or are stored, which define predetermined properties of the module, wherein the control device is set up and designed to control different modules using the module parameters, so that modules can be exchanged in the device for the additive manufacturing of components and these can be controlled by the control device, preferably without any further set-up procedure is a production control unit and wherein this control device also comprises the planning control unit and, in this way, forms the control device.

23. The planning control unit according to claim 17, wherein at least one distance sensor is provided, preferably for electro-optical distance measurement, in order to optically monitor the position of the processing heads.

24. The method according to claim 14, wherein a device for the additive manufacturing of components is used, preferably by means of selective melting or sintering comprising
at least one module with a processing head for directing a light beam onto a processing area, and a swivel arm on which the processing head is arranged, and a carriage on which the swivel arm is rotatably mounted, wherein the module can be moved along a rail device, and a control device in which module parameters can be stored or are stored, which define predetermined properties of the module, wherein the control device is set up and designed to control different modules using the module parameters, so that modules can be exchanged in the device for the additive manufacturing of components and these can be controlled by the control device, preferably without any further set-up procedure.

25. The method according to claim 24, wherein a planning control unit for automatically generating a production process plan for manufacturing a specific component by means of the device for the additive manufacturing,
wherein the planning control unit is set up and designed to create at least one production process plan on the basis of CAD data of the component to be manufactured,
wherein
the planning control unit is set up and designed such that an optimised configuration is determined on the basis of the CAD data of the component to be manufactured, and a production process plan is created on the basis of the optimised configuration, wherein
in particular a plurality of production process plans are created for different configurations of the additive manufacturing device, in which the different configurations are defined by means of different module parameters, so that one of the plurality of production process plans can be selected with regard to the parameters of production time and/or product quality

26. The method according to claim 25, wherein the device for the additive manufacturing of components, preferably by means of selective melting or sintering, comprises
at least one module with a processing head for directing a light beam onto a processing area, and a swivel arm on which the processing head is arranged, and a carriage on which the swivel arm is rotatably mounted, wherein the module can be moved along a rail device, and a control device in which module parameters can be stored or are stored, which define predetermined properties of the module, wherein the control device is set up and designed to control different modules using the module parameters, so that modules can be exchanged in the device for the additive manufacturing of components and these can be controlled by the control device, preferably without any further set-up procedure.
